(19) United States
(12) Patent Application Publication
(10) Pub. No.: US 2009/0279295 A1
(43) Pub. Date: Nov. 12, 2009

(54) TRANSPARENT BODY COMPRISING AT LEAST ONE EMBEDDED LED

(75) Inventor: Lucas Leo Desiree Van Der Poel, Eindhoven (NL)

Correspondence Address: Philips Intellectual Property and Standards, P.O. Box 3001, Briarcliff Manor, NY, 10510-8001, US

(73) Assignee: Koninklijke Philips Electronics N.V., Eindhoven (NL)

(21) Appl. No.: 12/306,751

(22) PCT Filed: Jul. 3, 2007
(86) PCT No.: PCT/IB2007/052579

§ 371 Date: Dec. 29, 2008

(30) Foreign Application Priority Data
Jul. 11, 2006 (EP) 06116969.4

(51) Int. Cl. F21V 1/00

(52) U.S. Cl. 362/235

(57) ABSTRACT

A transparent body comprising at least one embedded LED is disclosed. The embedded LED is arranged to provide a beam of light through the transparent body. The transparent body further comprises an optical device for controlling the beam angle and/or beam direction of at least a part of the light beam of the at least one embedded LED. The transparent body, provided with an optical device, allows improved illumination of entities displayed in, for example, showcases and counters.

### FIELD OF THE INVENTION

The present invention relates to a transparent body. The invention further relates to an optical device for use in combination with a transparent body with at least one embedded LED device and a sticker sheet comprising a plurality of optical devices for use in combination with a transparent body with at least one embedded LED.

### BACKGROUND OF THE INVENTION

In museums, shops and at home, transparent bodies are used in showcases and cabinets to display products. To illuminate the objects in the showcases and cabinets, halogen spots, strip lighting or Fiber Optic Lighting Systems (FOLS) are used in or outside the showcase.

### OBJECT AND SUMMARY OF THE INVENTION

It is an object of the present invention to provide an alternative transparent body having preferably improved illumination characteristics.

This object is achieved by a transparent body comprising at least one embedded LED, wherein the at least one embedded LED is arranged to provide a beam of light through the transparent body. The transparent body further comprises an optical device for controlling the beam angle and/or beam direction of at least a part of the light beam of the at least one embedded LED.

The present invention is based on the recognition that showcases and cabinets are commonly used in museums, galleries, shops and at home to display items. To improve visibility or attractiveness, the items in a showcase or cabinet are illuminated by means of halogen spots or Fiber Optics Lighting Systems. Usage of halogen spots has the disadvantage that they produce much heat and UV load on the products, resulting in aging. Furthermore, they may block the direct view of products when the halogen spot is positioned in the showcase. Moreover, when halogen spots are used, it is almost impossible to illuminate the products without casting shadows. When such spots are positioned outside the showcase or cabinet, they have the further disadvantage that the viewer can come between them and the showcase, thereby hindering the light beam from reaching the product in the showcase or cabinet. Illumination of the items by means of the transparent body according to the invention renders it possible to illuminate them with substantially no heat load and ultraviolet UV load on products. Furthermore, as the embedded LEDs are built in the showcase, the viewer cannot obstruct the light beam, while shadow-free light on products can be obtained when a plurality of LEDs is embedded. Bare LEDs produce a wide-angle light beam, and the optical device controls the light beam of the bare LED so as to obtain the desired illumination of the products in the showcase. The light beam can be focused by controlling the beam angle and the beam axis of the light beam can be directed to the product by controlling the beam direction. In this way, the halogen spot or FOLS can be replaced by a very compact LED. The invention provides the possibility of casting light without shadows on a product wherein the light source is integrated in a showcase or counter in a way which is substantially non-obstructive to a viewer.

The invention has the further advantage that maintenance costs can be reduced. A LED has a much longer lifetime than a halogen spot. The lifetime of a light source can be defined as the period of time in which the intensity of the light source in lumen decreases by 30%. Normally, a halogen spot has a lifetime of maximally 2000 hours, whereas a LED has a lifetime of 50,000 hours. The use of a LED in a showcase renders the showcase with respect to the light source almost free from maintenance.

In an embodiment of the invention, the material of the transparent body is at least one of the materials selected from the group of glass, Plexiglas and plastic.

In an embodiment of the invention, the transparent body comprises a plurality of aligned embedded LEDs, the optical device being arranged to control the light beams of the plurality of aligned embedded LEDs. This feature allows providing an alternative for illumination by means of strip light. If the LEDs are aligned in the transparent body and the optical device controls the light beams of the LEDs equally, the strip lighting in the showcase can be replaced, while maintaining similar illumination conditions. Embodiments of the invention may thus comprise a plurality of LEDs with a corresponding plurality of optical devices, an optical device for controlling the light beams of a plurality of LEDs, or any combination of these possibilities.

In an embodiment of the invention, the optical device is detachably mounted on the transparent body. This feature allows adaptation of the illumination conditions of the transparent body with the embedded LEDs when the content of the showcase or cabinet changes. This allows a reduction of costs for redecoration by reusing the relatively expensive transparent body with the embedded LEDs, and adaptation of the illumination conditions by mounting suitable optical devices. The optical devices can be glued or mounted on the transparent body by means of a two-sided adhesive tape.

In an embodiment of the invention, the optical device is a converging lens. This feature allows a reduction of the beam angle of a wide-beam angle bare LED so as to obtain a spot illuminating a limited area, with which a viewer's attention is focused on a product or detail of said product in the showcase.

Similarly, in an embodiment, the device is a diverging lens. This feature allows use of a narrow-beam angle LED so as to obtain the limited area. Instead of a lens, a reflector or a combination of a reflector and a lens may be used to obtain the desired illumination.

In an embodiment of the invention, the optical device is embedded in the transparent body. This feature allows prevention of external damage to the optical device, such as scratches and pollution.

In an embodiment, the optical device forms part of a foil. This feature decreases the time to provide the desired illumination characteristics to a transparent body. A dedicated foil with the desired illumination characteristics can be made automatically for the transparent body comprising the embedded LEDs. With the foil mounted on the body, each embedded LED will obtain the corresponding optical device.

A further aspect of the invention relates to an optical device for use in combination with a transparent body with at least one embedded LED so as to obtain the transparent body as defined in any one of the claims.

Another aspect of the invention relates to a sticker sheet comprising a plurality of optical devices for use in combination with a transparent body with at least one embedded LED so as to obtain the transparent body as defined in any one of the claims. When sticker sheets are used, a plurality of optical devices with different characteristics can be provided to control the beam angle and/or beam direction on one sheet. The user, who decorates the showcase, can select the appropriate optical device so as to obtain the desired illumination.

It should be noted that a transparent body is known, for instance, from US2004/0185195. Said document discloses a transparent body in the form of laminated glass. Two glass layers are separated by a transparent solid non-glass interlayer or an air gap. The transparent solid non-glass layer or the air gap between the glass layers of the laminated glass is used to embed solid-state lighting devices.

### BRIEF DESCRIPTION OF THE DRAWINGS

The present invention will be described in detail, by way of example, with reference to the accompanying drawings, in which:

FIG. 1 is a schematic cross-section of a first embodiment of the invention;

FIG. 2 is a schematic cross-section of a second embodiment of the invention;

FIG. 3 is a schematic cross-section of a third embodiment of the invention;

FIGS. 4 to 9 show schematically some examples of use of transparent bodies according to the invention;

FIG. 10 illustrates the beam angle and beam axis;

FIG. 11 is a schematic perspective view of a fourth embodiment of the invention;

FIG. 12 is a schematic perspective view of a linear solution for an embodiment of an optical device, and

FIG. 13 is a schematic perspective view of another linear solution for an embodiment of an optical device.

### DESCRIPTION OF EMBODIMENTS

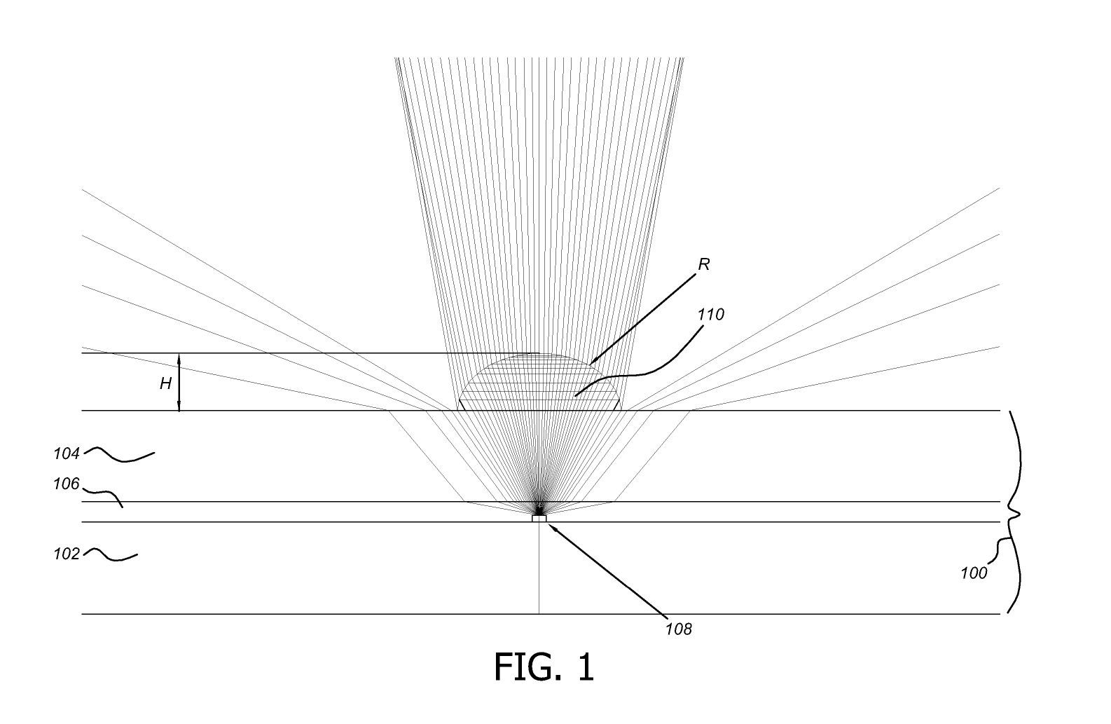

FIG. 1 is a schematic cross-section of a first embodiment of the invention. A laminated structure comprises a first transparent layer 102 and a second transparent layer 104 and forms a transparent body 100. In this embodiment, “transparent” is understood to mean that at least 80% of visible light is transmitted through the transparent body. Furthermore, the transparent body should preferably enable a viewer to see through with clarity. Examples of a transparent body are window panes and mirrors. The first and second transparent layers 102, 104 are separated by a transparent solid interlayer or an air gap 106. The first or second transparent layer 102, 104 may be a glass layer, a Plexiglas layer, a plastic layer, or any other suitable transparent material layer. The first and second transparent layers may be made of different materials or of the same material. The first and second layers may have a thickness in the range of 3 to 8 mm. The thickness of the transparent solid interlayer or air gap 106 may be in the range of 0.3 to 0.7 mm. However, the dimensions are not limited to these ranges and may depend on the application of the invention. At least one solid-state light source 108 is embedded between the first and the second layer 102, 104. “Embedded” is herein understood to mean that the solid-state light source or sources are enclosed firmly in the transparent body 100 and form an integral part of this body.

In general, a special layer is already used between the two transparent layers so as to change the properties of the transparent body. The purpose of this special layer is to improve the temperature-isolating qualities of the layer or to improve safety in case of breakage. Since the used layer, titan dioxide, is conductive, it is possible to use this layer for transporting power to the solid-state light sources to drive them. Tracks can be cut out and special layouts can be made by using laser techniques.

The solid-state light source 108 may be in the form of light-emitting diodes (LEDs), an opto-electric device consisting of a p-n junction that emits light in response to a forward current passing through the diode. LEDs are made from inorganic materials. The solid-state light source may also be in the form of organic light-emitting diodes (OLEDs). The OLEDs may be polymeric light-emitting diodes (PLEDs) or small molecule organic light-emitting diodes (SMOLEDs). Transparent electric conductors can be used to provide means for applying an activating voltage to the LEDs. For further details regarding the composition of the transparent body, reference is made to EP 1535885 A1 and US 2004/0185195.

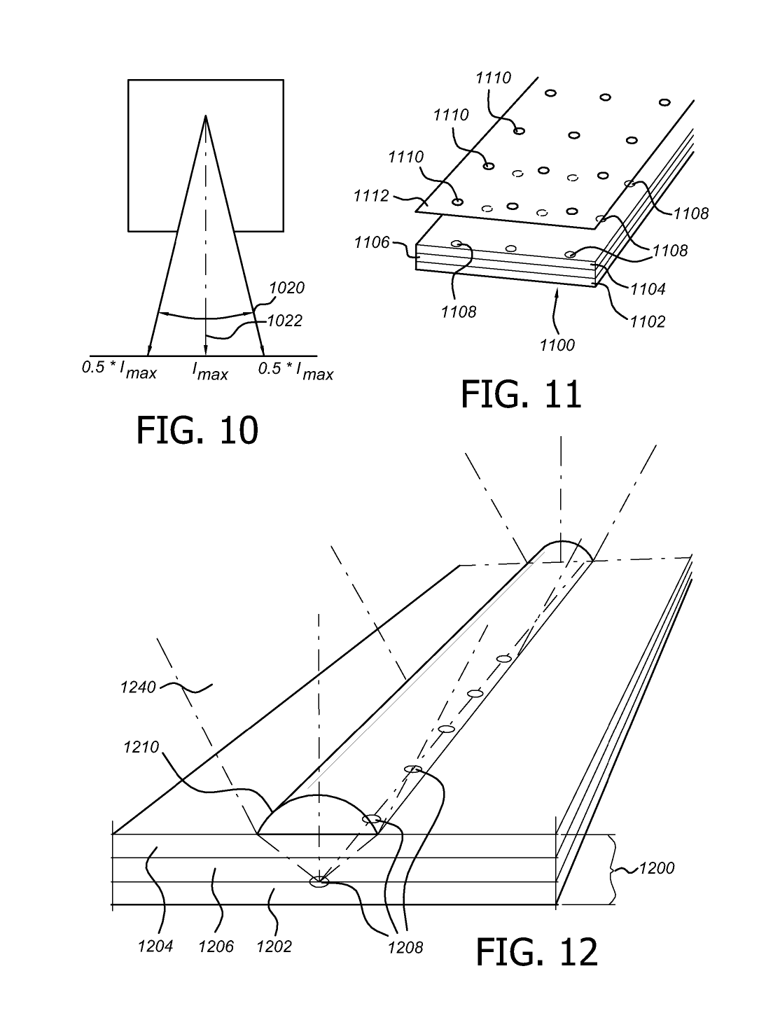

In FIG. 1, an optical device 110 in the form of a converging lens is (detachably) mounted on the transparent body. “Detachably” is herein understood to mean that the optical device 111 can be unfastened or disconnected without affecting the optical characteristics of the transparent body. The optical device 110 is situated in the light path of the light beam of the solid-state light source 108 and controls the beam angle of at least a part of the light beam. FIG. 10 illustrates the definition of beam angle 1020 and beam axis 1022. The beam angle 1020 is the angle between the two opposite directions on the beam axis 1022, wherein the luminous intensity is half that of the maximum luminous intensity Iₘₐₓ and the beam axis 1022 is the direction in the center of the beam angle 1020 within which the luminous intensity of a light beam is above a defined threshold (for example, 50%). The beam angle is decreased by means of the converging lens 110, resulting in a light spot with increased intensity. In this particular embodiment, the lens has a radius R of 3 mm and a height of 2 mm. The light spot can be used to illuminate an entity in a showcase with a higher intensity than without optical device 110, so that said entity attracts a potential customer's attention.

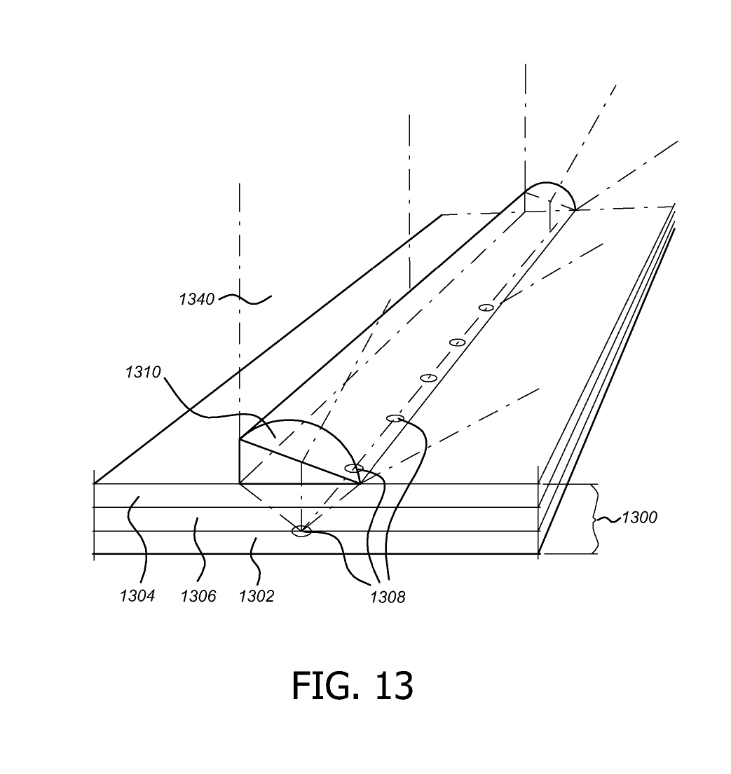

The optical device 110 in FIG. 1 is not arranged to adjust the beam axis of the light beam. The measures to be taken to obtain an optical device, which is suitable for controlling the beam angle and/or beam direction, will be evident to those skilled in the art. FIG. 13 illustrates an embodiment of an optical device 1310, which controls the beam angle and beam axis of the light beam 1340 from solid-state light sources 1308.

It can be seen from FIG. 1 that a wide-beam angle LED transmits light at a beam angle of almost 180°. A part of the light beam travels through the converging lens, resulting in a light spot of increased intensity.

The lens 110 may be mounted on the transparent body by means of a transparent glue or a transparent two-sided adhesive tape. A means for detachably mounting the optical device 110 on the transparent body 100 is preferably used. This has the advantage that in cases of, for example, redecoration of a showcase, the optical devices can be replaced with optical devices having light beam control characteristics, such as beam angle width and beam direction, with which the desired illumination of the entities in the showcase is obtained. In an embodiment, the optical devices are therefore in the form of a sticker, which can be obtained from a sticker sheet with a plurality of optical devices. An optical device in the form of a sticker allows quick and clean installation of the lenses on the surface of the transparent body. An embodiment of the sticker sheet comprises optical devices having different characteristics with respect to beam angle and beam direction. It is also possible to provide a “sticker book” containing a wider range of different lenses, so that the beam angle can be adapted to an end-user's specific needs. The sticker book may comprise, for example, lenses having a 5°, 10°, 30°, or 60° beam angle and an adjustment of the beam axis by 5°, 10°, 20°, 30° or 45°.

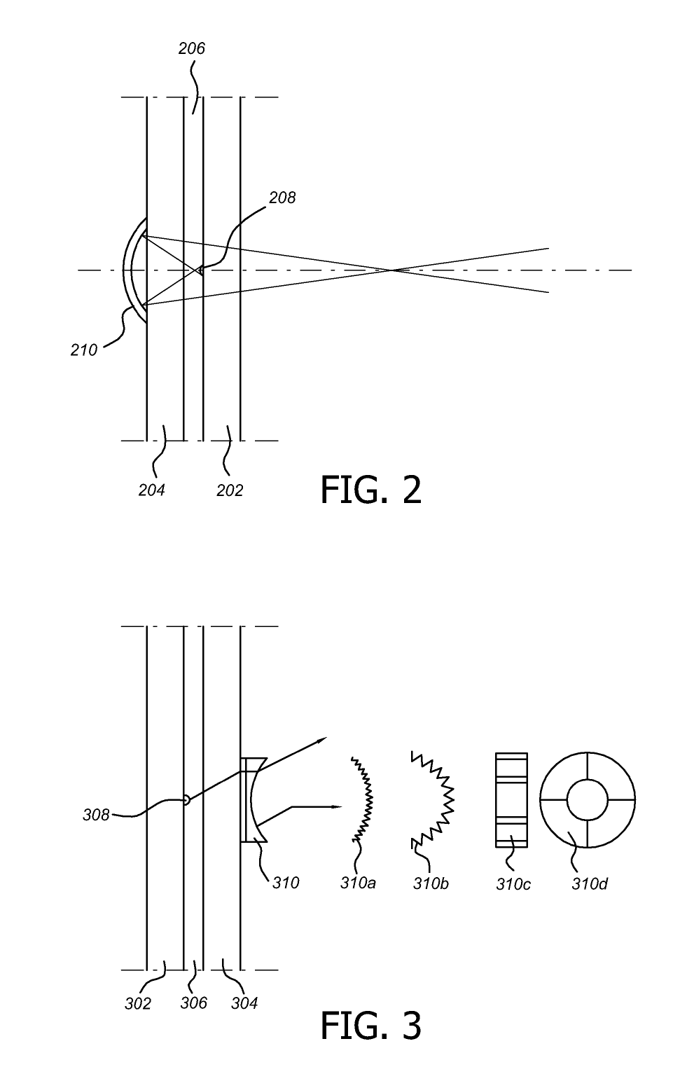

FIG. 2 is a schematic cross-section of a second embodiment of the invention. In this embodiment, an optical device 210 in the form of a bowl mirror reflector is positioned in the light path of the light beam generated by the solid-state light source 208. The solid-state light source 208 is mounted on a first transparent layer 202 and transmits the light beam via the air gap 206 through the second transparent layer 204 to the optical device 210. The optical device reflects and controls the beam angle and/or the beam direction. Optionally, the light beam has a focal point 212. Furthermore, the optical device is adapted to correct the light beam passing through the transparent body.

A point solution of an optical device 210 is an embodiment in the form of a circular lens. This embodiment is suitable for one optical light source or a plurality of juxtaposed optical light sources, for example, RGB LEDs. A circular or elliptic light spot can be obtained by means of this embodiment. FIG. 12 illustrates a linear solution for an embodiment of an optical device 1210. This embodiment is suitable for obtaining a linear light spot, equivalent to tube light. In the transparent body 1200 comprising a first transparent layer 1202, a second transparent layer 1204 and an interlayer 1206, a plurality of solid-state light sources 1208 is aligned in such a way that the linear optical device is situated in the light beams 1240 of the plurality of solid-state light sources 1208 to allow control of the beam angle and beam direction of the light beams 1240. If the solid-state light sources are in alignment, a linear optical device can be arranged to obtain a light beam which is similar to the light beam from a lighting unit emitting tube light. To obtain a uniform illumination of an entity from all directions, the solid-state light source may be aligned annularly. In combination with a ring-shaped optical device, an entity in a showcase can be illuminated from each side. FIG. 13 shows another linear solution for an embodiment of an optical device 1310. In this embodiment, the optical device 1310 is arranged to control both the beam angle and the beam direction of at least a part of the light beams of an array of LEDs 1308 embedded in a transparent body 1300. The point solution and the linear solution are both available for optical devices in the form of a lens and a reflector.

FIG. 3 is a schematic cross-section of a third embodiment of the invention. In this embodiment, the optical device 310 is in the form of a diverging lens. This embodiment is also suitable in combination with narrow-beam angle light sources 308. The narrow-angle light beam is widened by means of the diverging lens. The surface of the optical device, such as a converging or diverging lens, can be treated to obtain special effects. Examples of treated surfaces are an opaque surface 310a, a prismatic surface 310b and an optical device with louvers 310c, 310d. Opaque and prism (3D-print) texture can be added to influence the light distribution or to improve color mixing of individual (RGB) LED. Louvers or barn doors can be added to minimize glare which, at certain viewing angles, may be disturbing to the viewer

In a specific embodiment, the optical devices may further be used as color filters by using optical devices comprising a material with an optical filter function. In this way, the color of the illumination light may be adapted to the user's wishes.

The invention has the advantage that lighting units or luminaires can be made with environmental-friendly materials. The use of LEDs allows having a Color Rendering Index CRI, which is larger than 70, 80 or 85. As the solid-state light source is hermetically sealed in the transparent body, lighting units with a high Ingress Protection (IP) rating can be obtained, making it possible to use them in almost any application. The Ingress Protection (IP) rating scheme is an internationally recognized system of denoting the degree of protection afforded by various products against (a) access to hazardous parts, and (b) harmful ingress of water. It is a very simple system comprising two numbers, the first referring to access to parts, the second to water ingress. Furthermore, the brightness of LEDs can be adjusted very easily from 0 to 600 lumens per square meter. Moreover, LEDs have a very long lifetime of up to 50,000 hours, making the use of the invention very maintenance-free with respect to replacement of lamps. In most applications, the product lifetime of the device in which the invention is incorporated is shorter than the lifetime of the LEDs. One of the reasons for the long lifetime is the fact that LEDs are shockproof. This allows use of the invention in movable parts, such as doors or windows. The low driving voltage ensures safe use of the invention.

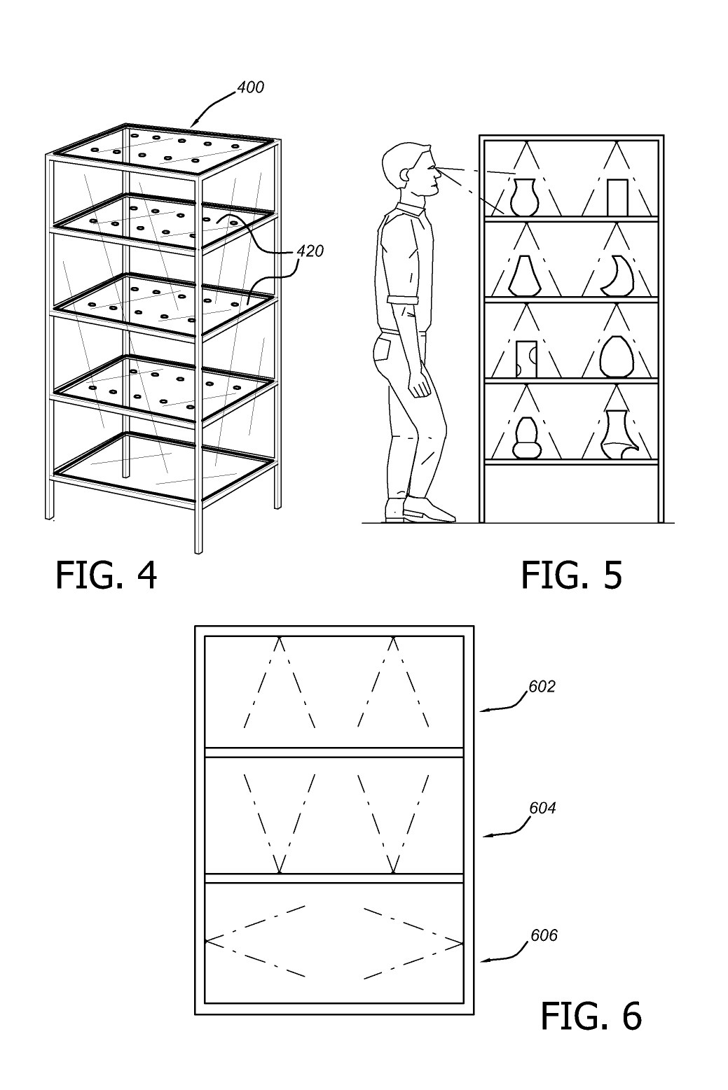

FIGS. 4 to 9 show schematically some examples of use of transparent bodies according to the invention. FIG. 4 shows a showcase 400 in which the transparent body forms the shelves of the showcase. A shelf can be regarded to be a lighting unit 420 for the showcase. The lighting unit 420 is a laminated glass plate with embedded LEDs. The LEDs can be aligned to form a two-dimensional array, comprising, for example, 1 LED/10 cm²-1 LED/100 cm². The optical devices mounted on the laminated glass plate form a starry sky for glare on products. A shelf with a plurality of embedded LEDs provides good shadow-free light on products. FIG. 5 is a side view of the showcase shown in FIG. 4. All shelves are arranged to illuminate the entities in the showcase from above. Each combination of LED and optical devices illuminates a particular area of the shelf below.

FIG. 6 shows three embodiments of illumination. The transparent body according to the invention can be used to illuminate an entity from above 602, from below 604 and sideways 606. It will be clear that the LEDs can be positioned in such a way that an entity can be illuminated from all sides. The invention allows illumination of an entity from the viewing side without obstructing the visitor's view. Due to the small size of the LEDs and the fact that people normally look with two eyes, no part or at least a very small part of the entity will be hidden behind the LEDs or the optical device.

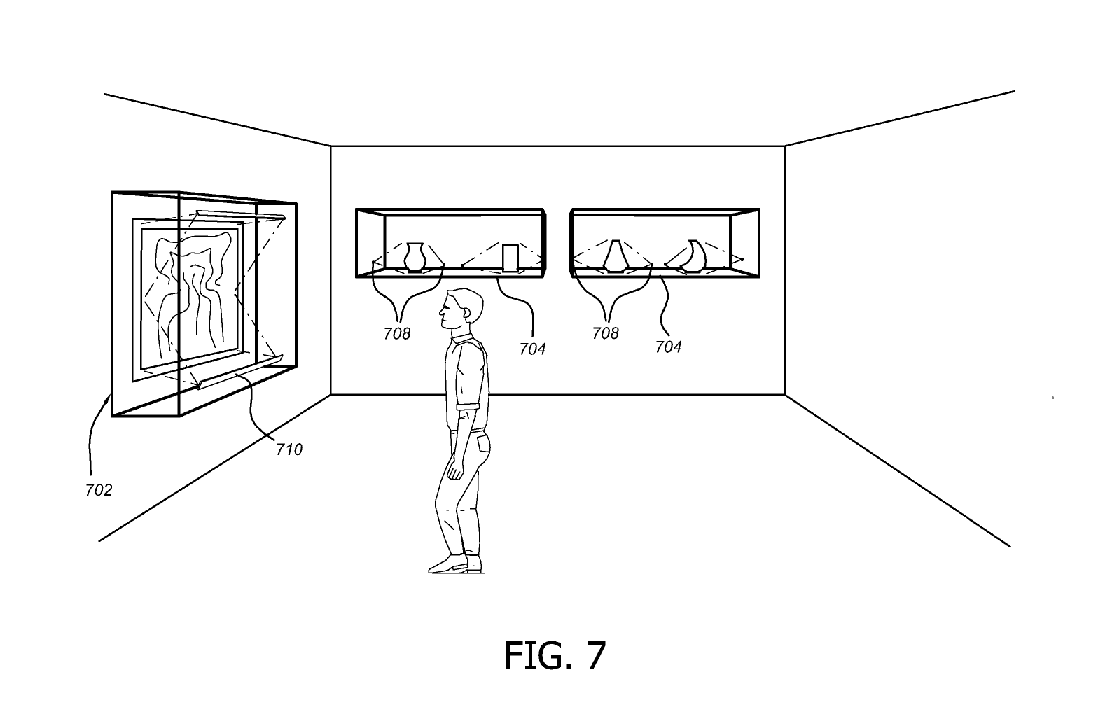

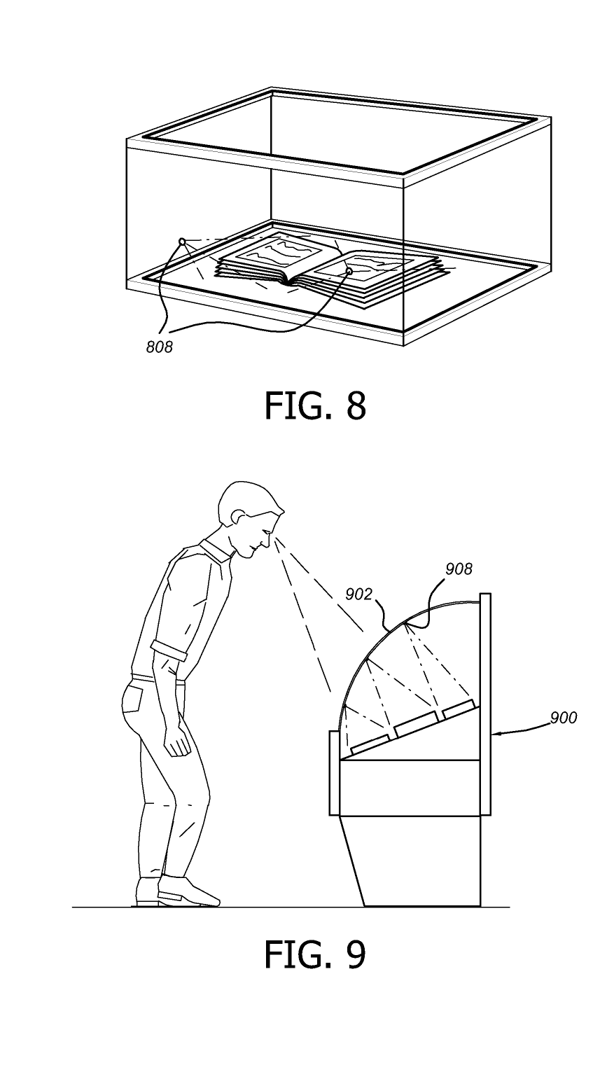

FIG. 7 shows an impression of an exhibition hall. In a display case 702 comprising a painting, the invention is applied to replace lighting units with strip light, such as fluorescent tubes. On the top and bottom of the display case 702, an array of LEDs is embedded in the glass plate so as to form a linear light source. A linear optical device 710, in the form of a linear lens or reflector, is mounted on the window of the display case in the light beams of the array of LEDs. The linear lens or reflector controls the beam angle and beam direction of the light beams to illuminate the painting in the display case 702. Furthermore, two built-in display cases 704 are shown. In the front glass plates, LEDs 708 are embedded to illuminate the entities in the showcase in the front. FIG. 8 shows another embodiment of a showcase. The LEDs 808 and corresponding optical devices are aligned to illuminate the book in the showcase. In this way, a viewer's attention is directed toward the book and not to the remaining space of the showcase.

FIG. 9 is a side view of a sales counter 900. LEDs 908 are embedded in the glass of the sales counter. Lenses are provided to control the beam angle and beam direction of the light beam from the LED. In this way, the products in the sales counter can be illuminated very well. In, for example, a butcher shop or a grocery store, the use of LEDs has the advantage that they do not produce excessive heat, which may affect the quality of the products on display in the sales counter. Furthermore, LEDs which do not produce substantially ultraviolet and/or infrared light may be used. In this way, discoloration of the products is reduced. Another advantage of replacing the conventional illumination by illumination according to the invention is that breakable lamps, which are normally made of glass, can be removed from the counter and thus reduce the risk of glass parts in the products.

FIG. 11 is a perspective view of a fourth embodiment of the invention. In this embodiment, a foil 1112 provided with a plurality of optical devices 1110 is mounted on the transparent body 1100. The transparent body 1100 comprises a first transparent layer 1102 and a second transparent layer 1104. There is an air gap 1106 between the first and the second layer. LEDs 1108 are embedded between the first and the second transparent layer. The LEDs are aligned in a two-dimensional array. The LEDs have a corresponding optical device 1110 forming part of the foil 1112. A foil comprising the optical devices decreases the time to provide the desired illumination characteristics to a transparent body 1100. A dedicated foil 1112 with the desired illumination characteristics can be made automatically for the transparent body 1100 comprising the embedded LEDs 1108. With the foil mounted on the body, each embedded LED will obtain the corresponding optical device. The foil may be detachably mounted on the transparent body by means of an adhesive or an electrostatic material.

In addition to the applications shown in FIGS. 4 to 9, other areas of application are possible. The invention may not only be used in showcases, display tables, museum cabinets, but also in mirrors of dressing rooms or bathrooms. The invention may also be used in the transparent walls of a shower or aquarium. It can be used to obtain high-end light fittings or luminaires, for example, for use above tables. The areas of application are almost unlimited, as a completely flat light solution may be provided. Furthermore, the use of LEDs enables light colors to be adapted for special effects, for example, warm light in wintertime and cool light in summertime.

It should be noted that the solid-state light source in the embodiments described above is situated on the first transparent layer and the optical device is mounted on the second transparent layer. If the invention is applied in a mirror, the solid-state light source and optical device may be mounted on the same layer. In such an embodiment, the solid-state light source may emit the light beam to the mirror, which in turn reflects the light beam passing through the layers and the optical device.

Though the invention has been described with reference to preferred embodiments, it is to be understood that these are non-limitative examples. Thus, various modifications are conceivable to those skilled in the art, without departing from the scope of the invention as defined in the claims. In the described embodiments, the layers of the body in which the solid-state light sources are embedded are transparent. However, when a lens is applied, only the second layer needs to be transparent. This allows use of the invention in non-transparent sidewalls of a showcase. Furthermore, a combination of lens and reflector may be used. In that case, a lens is mounted on the side of the transparent body opposite to the side on which the reflector is mounted.

Use of the verb “to comprise” and its conjugations does not exclude the presence of elements or steps other than those stated in a claim. Furthermore, use of the article “a” or “an” preceding an element does not exclude the presence of a plurality of such elements. In the claims, any reference signs placed between parentheses shall not be construed as limiting the scope of the claims. Furthermore, the invention resides in each and every novel feature or combination of features.

1. A transparent body comprising at least one embedded LED, the embedded LED being arranged to provide a beam of light through the transparent body, further comprising an optical device for controlling the beam angle and/or beam direction of at least a part of the light beam of the at least one embedded LED, wherein the optical device is detachably mounted on the transparent body.

2. A transparent body as claimed in claim 1, wherein the material of the transparent body is selected from the group consisting of: glass, Plexiglas and plastic.

3. A transparent body as claimed in claim 1, wherein the transparent body comprises a plurality of aligned embedded LEDs, the optical device being arranged to control the light beams of the plurality of aligned embedded LEDs.

4. (canceled)

5. A transparent body as claimed in claim 1, wherein the optical device is glued on the transparent body.

6. A transparent body as claimed in claim 1, wherein the optical device is mounted on the transparent body by means of a two-sided adhesive tape.

7. A transparent body as claimed in claim 1, wherein the optical device is a converging lens.

8. A transparent body as claimed in claim 1, wherein the optical device is a diverging lens.

9. A transparent body as claimed in claim 1, wherein the optical device is a reflector.

10. A transparent body as claimed in claim 1, wherein the optical device comprises a lens and a reflector.

11-12. (canceled)

13. A transparent body as claimed in claim 1, further comprising a first transparent layer, a second transparent layer, wherein the at least one embedded LED is embedded between the first and the second layer.

14-17. (canceled)
